(19) United States
(12) Patent Application Publication
(10) Pub. No.: US 2018/0224568 A1
(43) Pub. Date: Aug. 9, 2018

(54) METHODS AND SYSTEMS FOR DEPLOYMENT OF SEISMIC AUTONOMOUS UNDERWATER VEHICLES

(71) Applicant: Seabed Geosolutions B.V., Leidschendam (NL)

(72) Inventors: Thierry Brizard, Ollainville (FR); Erwan Francois Marie Postic, Houston, TX (US)

(73) Assignee: Seabed Geosolutions B.V., Leidschendam (NL)

(21) Appl. No.: 15/888,935

(22) Filed: Feb. 5, 2018

Related U.S. Application Data
(60) Provisional application No. 62/455,417, filed on Feb. 6, 2017.

(51) Int. Cl. G01V 1/38; B63G 8/39; B63G 8/08; B63G 8/16; B63G 8/00; B63G 8/22

(52) U.S. Cl. CPC G01V 1/3852; B63G 8/39; G01V 1/3835; G01V 1/3808; B63B 2211/02; B63G 8/16; B63G 8/001; B63G 8/22; B63G 2008/004; B63G 8/08

(57) ABSTRACT

Systems and methods for deploying seismic autonomous underwater vehicles (AUVs) to the seabed by using a variety of guidance systems and/or positioning/communication protocols based on a particular AUV's location. A combination of a USBL system and a phased array system may be used to deploy different groups of AUVs on one or more deployment lines of a seismic survey area. The deployment lines may be generally perpendicular or parallel to a deployment vessel's direction of travel. Once a certain number of AUVs have landed on the seabed, the landed AUVs may be used to guide flying AUVs to their intended seabed destination by using acoustic pingers and phased array techniques. Time intervals for acoustic signals emitted from landed AUVs may be generated using a predetermined Time of Emission pattern and received by a phased array receiver on flying AUVs.

### PRIORITY

This application claims priority to U.S. provisional patent application No. 62/455,417, filed on Feb. 6, 2017, the entire content of which is incorporated herein by reference.

### BACKGROUND OF THE INVENTION

### Field of the Invention

This invention relates to marine seismology and more particularly relates to the deployment of ocean bottom seismic autonomous underwater vehicles (AUVs).

### Description of the Related Art

Marine seismic data acquisition and processing generates a profile (image) of a geophysical structure under the seafloor. Reflection seismology is a method of geophysical exploration to determine the properties of the Earth's subsurface, which is especially helpful in determining an accurate location of oil and gas reservoirs or any targeted features. Marine reflection seismology is based on using a controlled source of energy (typically acoustic energy) that sends the energy through a body of water and subsurface geologic formations. The transmitted acoustic energy propagates downwardly through the subsurface as acoustic waves, also referred to as seismic waves or signals. By measuring the time it takes for the reflections or refractions to come back to seismic receivers (also known as seismic data recorders or nodes), it is possible to evaluate the depth of features causing such reflections. These features may be associated with subterranean hydrocarbon deposits or other geological structures of interest.

There are many methods to record the reflections from a seismic wave off the geological structures present in the surface beneath the seafloor. In one method, a marine vessel tows an array of seismic data recorders provided in streamers. In another method, seismic data recorders are placed directly on the ocean bottom by a variety of mechanisms, including by the use of one or more of Autonomous Underwater Vehicles (AUVs), Remotely Operated Vehicles (ROVs), by dropping or diving from a surface or subsurface vessel, or by attaching autonomous seismic nodes to a cable that is deployed behind a marine vessel. The data recorders may be discrete, autonomous units, with no direct connection to other nodes or to the marine vessel, where data is stored and recorded.

Emerging technologies in marine seismic surveys need a fast and cost-effective system for deploying and recovering seismic receivers that are configured to operate underwater, and in particular ocean bottom seismic nodes. Newer technologies use AUVs that have a propulsion system and are programmed to move to desired positions and record seismic data. In general, the basic structure and operation of a seismic AUV is well known to those of ordinary skill. For example, Applicant's U.S. Pat. No. 9,090,319, incorporated herein by reference, discloses one type of autonomous underwater vehicle for marine seismic surveys. Applicant's U.S. Patent Publication No. 2017/0137098, incorporated by reference, discloses another type of seismic AUV. Further, it is also generally known how to guide AUVs to the bottom of the ocean to land at predetermined positions, such as that disclosed in Applicant's U.S. Pat. Nos. 9,845,137 and 9,873,496, each incorporated herein by reference.

Because a seismic survey may require hundreds if not thousands of AUVs for a particular survey, an AUV is needed that is easy to operate and relatively straightforward and cost-effective to manufacture. However, existing technologies for deploying a seismic AUV to the ocean bottom are not cost effective and present many operational problems. A need exists for an improved seismic AUV deployment method that is more cost effective and less complex, more reliable, and able to deploy thousands of seismic AUVs in an efficient manner.

### SUMMARY OF THE INVENTION

Systems and methods for deploying seismic autonomous underwater vehicles (AUVs) to the seabed by using a variety of guidance systems and/or positioning/communication protocols based on a particular AUV's location. A combination of a USBL system and a phased array system may be used to deploy different groups of AUVs on one or more deployment lines of a seismic survey area. The deployment lines may be generally perpendicular or parallel to a deployment vessel's direction of travel. Once a certain number of AUVs have landed on the seabed, the landed AUVs may be used to guide flying AUVs to their intended seabed destination by using acoustic pingers and phased array techniques. Time intervals for acoustic signals emitted from landed AUVs may be generated using a predetermined Time of Emission pattern and received by a phased array receiver on flying AUVs.

In one embodiment, disclosed is a method for performing a marine seismic survey in a body of water. The method may comprise deploying a first plurality of seismic autonomous underwater vehicles (AUVs) to a first plurality of seabed positions using a first guidance system, deploying a second plurality of seismic AUVs into the body of water, and guiding the second plurality of seismic AUVs to a second plurality of seabed positions using a second guidance system based on acoustic signals emitted by the first plurality of seismic AUVs after landing on the seabed. The method may further comprise guiding at least some of the second plurality of seismic AUVs based on acoustic signals emitted by previously landed AUVs within the second plurality of AUVs. The method may further comprise deploying the first and second plurality of seismic AUVs in a plurality of deployment lines on both sides of a surface vessel. In one embodiment, each of the plurality of deployment lines may be substantially parallel to the direction of travel of the surface vessel, while in other embodiments each deployment line may be substantially perpendicular to the direction of travel. In one embodiment, the first guidance system is a USBL system and the second guidance system is a phased array system. The method may further comprise landing the second plurality of seismic AUVs on the seabed based on signals received by the first plurality of seismic AUVs and without guidance by a surface vessel.

The method may further comprise deploying a plurality of first deployment lines on both sides of a deployment surface vessel as the vessel travels in a first direction, wherein each of the first deployment lines is substantially parallel to the first direction of travel of the vessel and deploying a plurality of second deployment lines on both sides of the vessel as it travels in a second direction, wherein each of the second deployment lines is substantially parallel to the second direction of travel of the vessel. The second direction may be substantially parallel and opposite to the first direction, and each of the first and second plurality of deployment lines may comprise a plurality of landed seismic AUVs guided to the seabed using phased array.

The method may further comprise emitting acoustic pulses from a plurality of landed seismic AUVs after landing on the seabed, receiving the emitted pulses by a plurality of flying seismic AUVs, and determining positions of each of the plurality of flying seismic AUVs by the received emitted pulses.

The method may further comprise landing each of the plurality of flying seismic AUVs on predetermined seabed positions based on the received emitted pulses. The method may further comprise emitting acoustic pulses at a first frequency from a first plurality of landed seismic AUVs on a first deployment line and emitting acoustic pulses at a second frequency from a second plurality of landed seismic AUVs on a second deployment line. The method may further comprise guiding a flying AUV across one or more deployment lines and upon crossing an intended destination deployment line guiding the flying AUV substantially in-line with the intended destination deployment line until reaching a target seabed position on the intended destination deployment line.

In one embodiment, disclosed is a system for performing a marine seismic survey on the seabed. The system may comprise a first deployment line on the seabed comprising a first plurality of seismic AUVs and a second plurality of seismic AUVs. The first plurality of AUVs may be configured to be guided to the seabed using USBL and the second plurality of AUVs may be configured to be guided to the seabed using phased array.

The AUVs of each deployment line may be configured to emit acoustic pulses at a particular frequency after landing. A time interval of the emitted pulses may be determined by a Time of Emission (TOE) pattern, wherein each AUV after landing is configured to emit an acoustic pulse at a different time slot. The TOE pattern may repeat itself a plurality of times across a plurality of different AUV groups for each of the first and second deployment lines. The TOE pattern may create at least a predetermined minimum separation between the emitted pulses received by an approaching seismic AUV.

The system may further comprise a second deployment line on the seabed comprising a third plurality of seismic AUVs and a fourth plurality of seismic AUVs, wherein each AUV of the third plurality of seismic AUVs is configured to be guided to the seabed using USBL, wherein each AUV of the fourth plurality of seismic AUVs is configured to be guided to the seabed using phased array, wherein each of the AUVs of the first deployment line is configured to emit acoustic pulses at a first frequency after landing and each of the AUVs of the second deployment line is configured to emit acoustic pulses at a second frequency after landing.

Each of the AUVs may have a phased array receiver that is configured to receive acoustic signals emitted by previously landed seismic AUVs. Each AUV may have a phased array system that is configured to guide the AUV to a seabed destination based on received acoustic signals emitted by previously landed seismic AUVs.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates one embodiment of a schematic diagram of an AUV.

FIG. 2 illustrates a side schematic view of a deployment system according to one embodiment of the present disclosure.

FIG. 3 illustrates a top schematic view of a deployment system to deploy seismic AUVs to the seabed according to one embodiment of the present disclosure.

FIGS. 4A-4D illustrate a top schematic view of a deployment system to deploy seismic AUVs to the seabed according to another embodiment of the present disclosure.

FIGS. 5A-5F illustrate a top schematic view of various operational aspects of a guidance system according to one embodiment of the present disclosure.

FIG. 6 illustrates a top schematic view of various operational aspects of a guidance system according to one embodiment of the present disclosure.

FIGS. 7A-7B illustrate one embodiment of a Time of Emission (TOE) pattern according to one embodiment of the present disclosure.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### Autonomous Underwater Vehicles and Components Thereof

In one or more embodiments, an autonomous underwater vehicle (AUV) is used to record seismic signals on or near the seabed. A seismic AUV in the following description is considered to encompass an autonomous self-propelled underwater node that has one or more sensors capable of detecting seismic waves in a marine environment. The following embodiments are discussed, for simplicity, with regard to the terminology and structure of an AUV with seismic sensors for recording seismic waves. In general, the structure and operation of a seismic AUV is well known to those of ordinary skill. For example, Applicant's U.S. Pat. No. 9,090,319, incorporated herein by reference, discloses one type of autonomous underwater vehicle for marine seismic surveys.

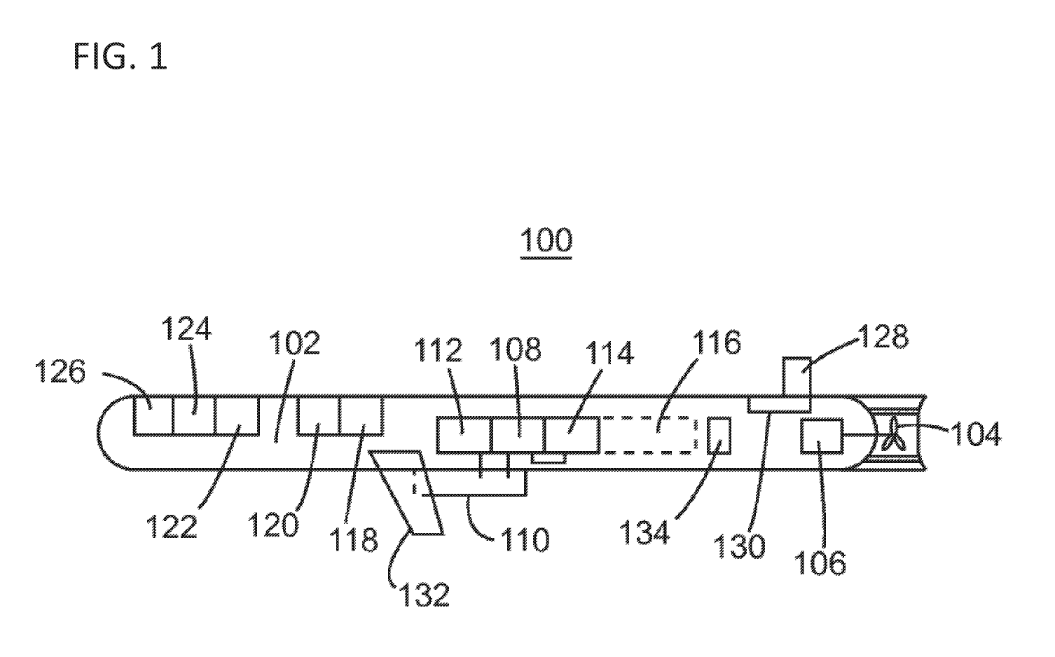

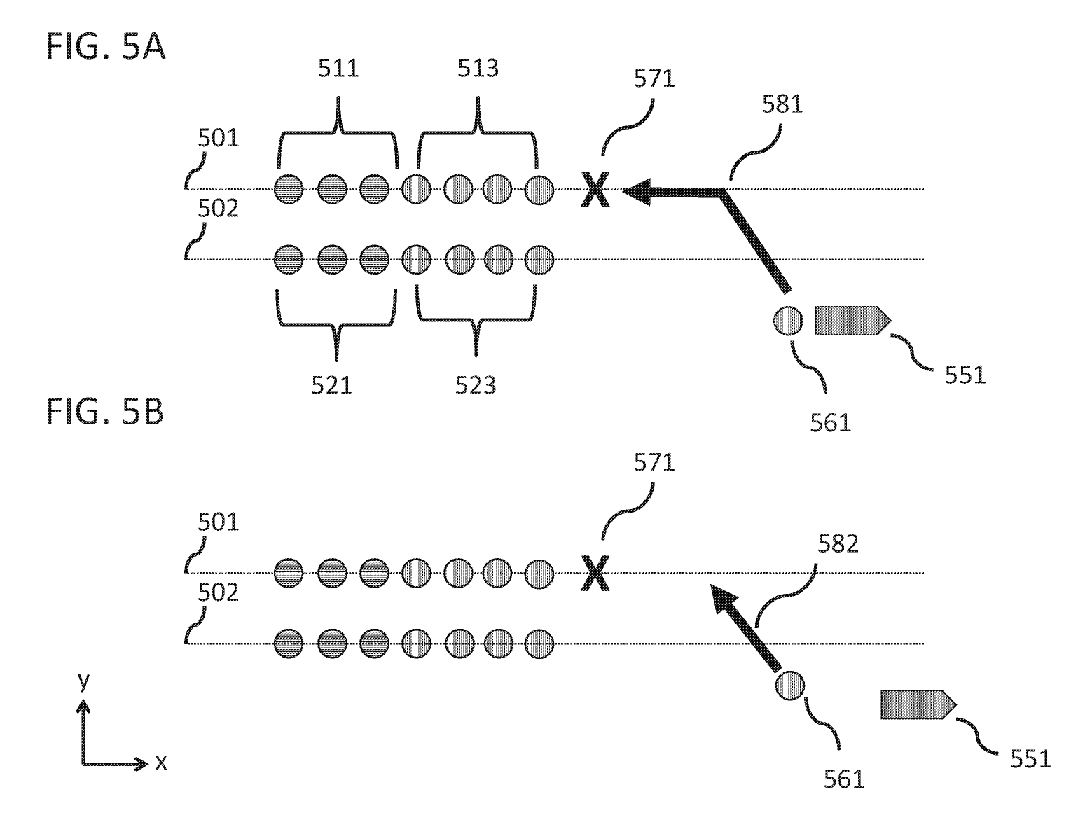

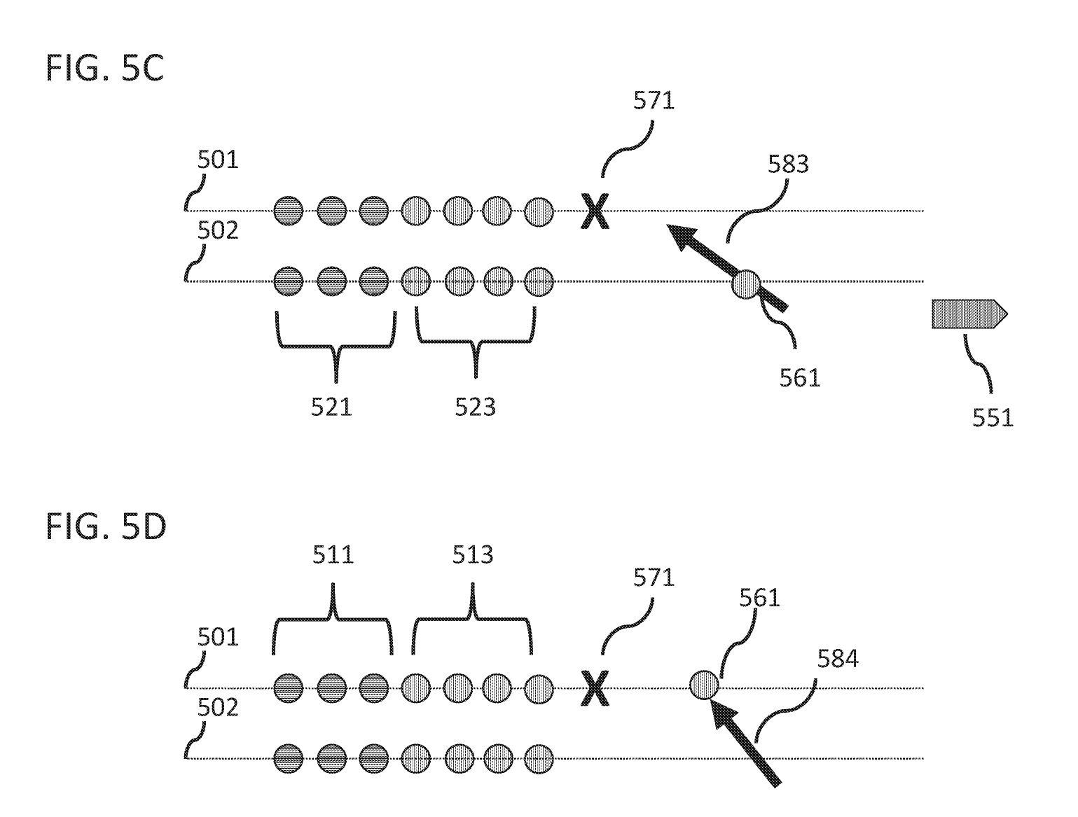

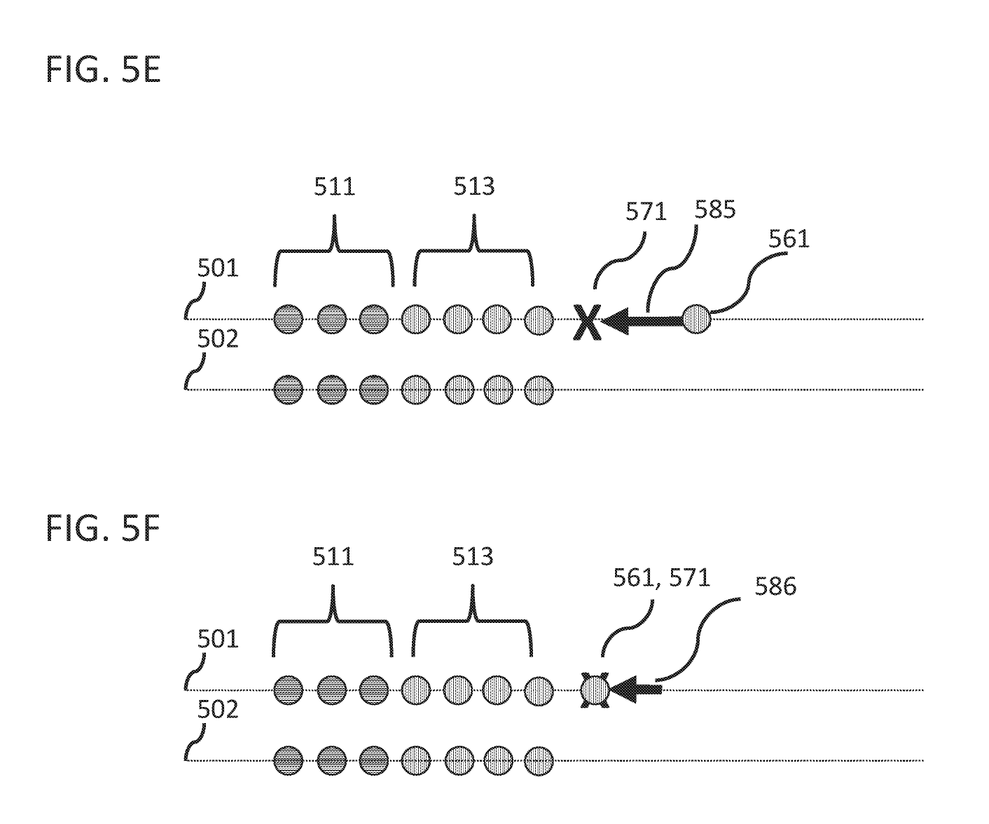

FIG. 1 is reproduced from FIG. 5 of Applicant's U.S. Pat. No. 9,090,319. The disclosed embodiment may use one or more systems, components, and/or features from the AUV described in FIG. 1. FIG. 1 illustrates one embodiment of AUV 100 having a body 102 in which a propulsion system may be located. The propulsion system may include one or more propellers 104 and a motor 106 for activating the propeller 104. Other propulsion systems may be used, such as jets, thrusters, pumps, etc. Further, the propellers (or other propulsion systems) may be located at various parts of the AUV, such as front, sides, or the top or bottom of the AUV, such as that disclosed in U.S. Patent Publication No. 2017/0137098, incorporated herein by reference. Alternatively, the propulsion system may include adjustable wings 132 for controlling a trajectory of the AUV. Motor 106 may be controlled by a processor/controller 108. Processor 108 may also be connected to one or more seismic sensors 110. Seismic sensor 110 may have a shape such that when the AUV lands on the seabed, the seismic sensor achieves a good coupling with the seabed sediment. The seismic sensor may include one or more of a hydrophone, geophone, accelerometer, etc. For example, if a 4C (four component) survey is desired, the seismic sensors may include three accelerometers and a hydrophone, i.e., a total of four sensors. Alternatively, the seismic sensor may include three geophones and a hydrophone. Of course, other sensor combinations are possible, and may include one or more of a hydrophone, geophone, accelerometer, electromagnetic sensor, depth sensor, MEMs, or a combination thereof. Seismic sensor 110 may be located completely or partially inside body 102. A memory unit 112 may be connected to processor 108 and/or seismic sensor 110 for storing seismic data recorded by seismic sensor 110. Power system 114 (such as one or more batteries) may be used to power all these components. Battery 114 may be allowed to shift its position along a track 116 to change the AUV's center of gravity. This shift may be controlled by processor 108. The AUV may also include a clock and digital data recorder (not shown).

In one embodiment, the AUV may also include an inertial navigation system (INS) 118 configured to guide the AUV within a body of water and to a desired location. An inertial navigation system may include a module containing accelerometers, gyroscopes, magnetometers, or other motion-sensing devices. The INS may initially be provided with the current position and velocity of the AUV from another source, for example, a human operator, a GPS satellite receiver, a deployed subsea station, a deployed ROV, another AUV, from one or more surface vessels, etc., and thereafter, the INS computes its own updated position and velocity by integrating (and optionally filtrating) information received from its motion sensors. One advantage of an INS is that it requires no external references in order to determine its position, orientation or velocity once it has been initialized. However, the INS may still require regular or periodic updates from an external reference to update the AUV's position to decrease the positioning error of the AUV, particularly after long periods of time subsea. As noted above, alternative systems may be used, as, for example, acoustic positioning. An optional acoustic Doppler Velocity Log (DVL) (not shown) can also be employed as part of the AUV, which provides bottom-tracking capabilities for the AUV. Sound waves bouncing off the seabed can be used to determine the velocity vector of the AUV, and combined with a position fix, compass heading, and data from various sensors on the AUV, the position of the AUV can be determined. This assists in the navigation of the AUV, provides confirmation of its position relative to the seabed, and increases the accuracy of the AUV position in the body of water. In other embodiments, and to reduce the complexity of the AUV, an INS may not be utilized.

Besides or instead of INS 118, the AUV may include compass 120 and other sensors 122 as, for example, an altimeter for measuring its altitude, a pressure gauge, an interrogator module, etc. The AUV 100 may optionally include an obstacle avoidance system 124 and a communication device 126 (e.g., Wi-Fi or other wireless interface, such as a device that uses an acoustic link) or other data transfer device capable of wirelessly transferring seismic data and/or control status data. One or more of these elements may be linked to processor 108. The AUV further includes antenna 128 (which may be flush with or protrude from the AUV's body) and corresponding acoustic system 130 for subsea communications, such as communicating with a deployed ROV (or other underwater station), another AUV, or a surface vessel or station. For surface communications (e.g., while the AUV is on a ship), one or more of antenna 128 and communication device 126 may be used to transfer data to and from the AUV. Stabilizing fins and/or wings 132 for guiding the AUV to the desired position may be used with propulsion system for steering the AUV. However, in one embodiment, the AUV has no fins or wings. The AUV may include buoyancy system 134 for controlling the AUV's depth and keeping the AUV steady after landing.

Acoustic system 130 may be an Ultra-Short Baseline (USBL) system, also sometimes known as Super Short Base Line (SSBL). This system uses a method of underwater acoustic positioning. A complete USBL system may include a transceiver or acoustic positioning system mounted on a pole under a vessel or ROV (such as Hi-PAP or μPAP, commercially available by Kongsberg) and a transponder on the AUV. In general, a hydro-acoustic positioning system consists of both a transmitter and a receiver, and any Hi-PAP or μPAP or transponder system acts as both a transmitter and a receiver. An acoustic positioning system uses any combination of communications principles for measurements and calculations, such as SSBL. In one embodiment, the acoustic positioning system transceiver comprises a spherical transducer with hundreds of individual transducer elements. A signal (pulse) is sent from the transducer (such as a Hi-PAP or μPAP head on the surface vessel), and is aimed towards the seabed transponder located on the AUV. This pulse activates the transponder on the AUV, which responds to the vessel transducer after a short time delay. The transducer detects this return pulse and, with corresponding electronics, calculates an accurate position of the transponder (AUV) relative to the vessel based on the ranges and bearing measured by the transceiver. In one embodiment, to calculate a subsea position, the USBL system measures the horizontal and vertical angles together with the range to the transponder (located in the AUV) to calculate a 3D position projection of the AUV relative to a separate station, basket, ROV, or vessel. An error in the angle measurement causes the position error to be a function of the range to the transponder, so an USBL system has an accuracy error increasing with the range.

Alternatively, a Short Base Line (SBL) system, an inverted short baseline (iSBL) system, or an inverted USBL (iUSBL) system may be used, the technology of which is known in the art. For example, in an iUSBL system, the transceiver is mounted on or inside the AUV while the transponder/responder is mounted on a separate vessel/station and the AUV has knowledge of its individual position rather than relying on such position from a surface vessel (as is the case in a typical USBL system). In another embodiment, a long baseline (LBL) acoustic positioning system may be used. In a LBL system, reference beacons or transponders are mounted on the seabed around a perimeter of a work site as reference points for navigation. The LBL system may use an USBL system to obtain precise locations of these seabed reference points. Thus, in one embodiment, the reference beacon may comprise both an USBL transponder and a LBL transceiver. The LBL system results in very high positioning accuracy and position stability that is independent of water depth, and each AUV can have its position further determined by the LBL system. The acoustic positioning system may also use an acoustic protocol that utilizes wideband Direct Sequence Spread Spectrum (DSSS) signals. In one embodiment, the AUV is equipped with a plurality of communication devices, such as an USBL beacon capable of receiving and transmitting acoustic signals, a phased array receiver (or system) that is able to determine the direction of an incoming acoustic signal by analysis of the signal phase, and an acoustic modem.

With regard to the AUV's internal configuration, the AUV includes a CPU that may be connected to an inertial navigation system (INS) (or compass or altitude sensor and acoustic transmitter for receiving acoustic guidance from the mother vessel), a wireless interface, a pressure gauge, and an acoustic transponder. The INS is advantageous when the AUV's trajectory has been changed, for example, because of an encounter with an unexpected object (e.g., fish, debris, etc.), because the INS is capable of taking the AUV to the desired final position as it encounters currents, wave motion, etc. Also, the INS may have high precision. For example, an INS may be accurate up to 0.1% of the travelled distance, and a USBL system may be accurate up to 0.06% of the slant range. Thus, it is expected that for a target having a depth of 1000 m, the INS and/or the acoustic guidance is capable of steering the AUV within +/−1 m of the desired target location. The INS may be also configured to receive data from a surface vessel and/or a deployed ROV to increase its accuracy. The AUV may include multiple CPUs. For example, a second CPU may be configured to control one or more attitude actuators and a propulsion system. One or more batteries may be located in the AUV. A seismic payload is located inside the AUV for recording the seismic signals. As another embodiment, an obstacle avoidance system may be included in the AUV, which is generally configured to detect an object in the path of the AUV and divert the AUV from its original route to avoid contact with the object. In one example, the obstacle avoidance system includes a forward-looking sonar. The AUV includes any necessary control circuitry and software for associated components. In one embodiment, the AUV may have various operational modes, such as wakeup, sleep, maintenance, and travel modes.

Those skilled in the art would appreciate that more or less modules may be added to or removed from the AUV. For example, the AUV may include variable buoyancy functionality, such as the ability to release a degradable weight on the bottom of the ocean after seismic recording to assist in the rise or surfacing of the AUV to a recovery spot (such as on or near the ocean surface). In other embodiments, the AUV may include one or more buoyancy or ballast tanks that may be flooded with air or water to assist in the vertical navigation of the AUV, such as described in more detail in Applicant's U.S. Patent Publication No. 2015/0336645, incorporated herein by reference. In another embodiment, the AUV may include a suction skirt that allows water to be pumped out of a compartment under the AUV after it has landed to create a suction effect towards the seabed. In still other embodiments, the AUV may include one or more seabed coupling mechanisms or self-burying functionality, such as the ability to rock or twist into the ocean by specific movements of the AUV or the use of a plurality of water outlets on the bottom of the AUV to fluidize the seabed sediment, as described in more detail in Applicant's U.S. Pat. Nos. 9,381,986 and 9,457,879, incorporated herein by reference.

In one embodiment, the deployment system of the present application requires minimal acoustic devices on the AUV, which decreases the overall cost of the AUV and guidance/deployment protocols during deployment and retrieval of the AUVs to and from the seabed. For example, for acoustic communications each AUV may only comprise a USBL beacon and a phased array system, such as but not limited to a Sonardyne beacon and an Arkeocean phase array system. In one embodiment, the phase array system may comprise a Combined Acoustic Phased Array (CAPA) and a Triton processing board. In one embodiment, the phased array is configured to intercept and/or receive the acoustic signals emitted by other seismic AUVs (such as previously landed seismic AUVs) and to guide the AUV to the seabed based on those received acoustic signals.

### AUV Deployment and Guidance Systems

The disclosed AUV deployment and guidance system provides numerous benefits over previously disclosed deployment systems and methods for outbound guidance of seismic AUVs from a deployment vessel to the seabed, including having AUVs that are less complex and more reliable, deploying a high number of AUVs within a relatively short time period, and more precise coordination for better seabed positioning of the AUVs. The disclosed system may be utilized whether the AUVs are deployed directly from a surface vessel or from a subsea station (such as a lowered basket). Further, one or more surface vessels may be utilized to deploy the AUVs and/or to communicate with the AUVs. Still further, the particular retrieval method of the AUVs is not limited by this invention, and a wide variety of retrieval options and inbound guidance protocols may be used to recover some or all of the AUVs.

In one embodiment, the disclosed deployment system and method uses a variety of guidance systems and/or communication protocols based on the particular AUV's location and deployment time, both relative to the surface vessel and the other AUVs. In one embodiment, the system uses a combination of a USBL system and an acoustic pinger system detected by a phase array system. In one embodiment, the disclosed guidance system uses a first positioning/communications system (such as USBL) to deploy a first plurality of AUVs to the seabed, and then uses a second positioning/communications system (such as a phase array detecting the acoustic pingers) to deploy a second plurality of AUVs to the seabed. Each of these positioning/communications systems, by themselves, is known in the art. However, the particular use of these different systems as described herein is novel and offers a much more efficient and effective AUV deployment model than currently available. The disclosed outbound guidance system is not particularly dependent on the particular seismic AUV utilized, as long as the AUV is able to communicate with the different types of USBL and/or acoustic pingers and/or phased array systems utilized in the disclosed guidance system.

In one embodiment, a USBL system is used to actively guide a first plurality of AUVs to the seabed, such as AUVs deployed to the seabed before any other AUVs are deployed to the seabed. The USBL system may be configured to measure the position of the AUV in flight to monitor each of the AUV trajectories. In one embodiment, some or all of the deployed AUVs are configured to act as sea bottom acoustic pingers, e.g., they are configured to emit an acoustic pulse at a given frequency and at a given time. In one embodiment, once a certain number of AUVs of a given deployment line have landed, their coordinates are measured by the USBL system and potentially given to a second plurality of AUVs, and the coordinates of the first plurality of AUVs may then be used to guide the second plurality of AUVs to their intended seabed destination. In one embodiment, a final guidance phase may be performed using a phased array system or receiver located on each AUV. Once a certain number of AUVs of a given deployment line has landed, each AUV may begin emitting pulses at its assigned frequency in its assigned time slot to therefore act as an additional pinger for guiding additional AUVs on the given deployment line. In some embodiments, the pinger is part of the phased array system. In some embodiments, a LBL system is not used, and a first plurality of AUVs are deployed to the seabed using a USBL system and a second plurality of AUVs are deployed to the seabed using a phased array system based on acoustic signals received from the previously landed AUVs.

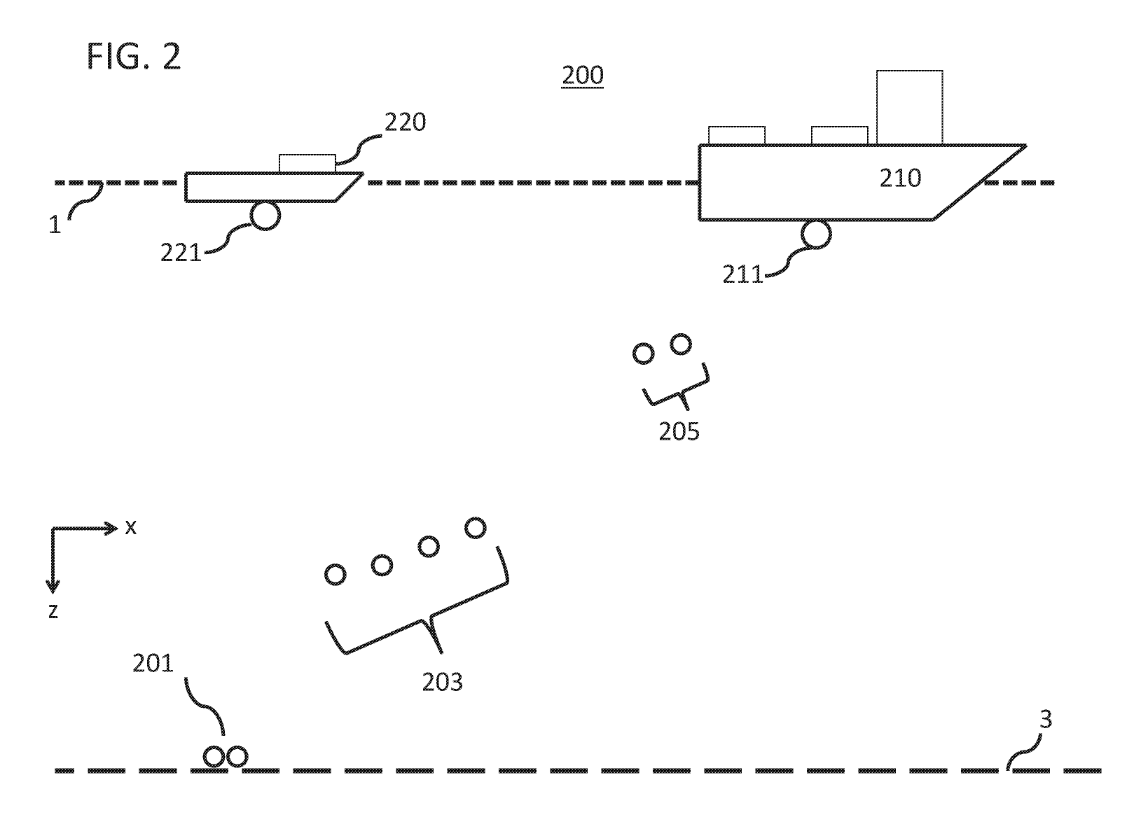

FIG. 2 illustrates one embodiment of an AUV deployment system 200 from a side view through a body of water. In one embodiment, deployment system 200 uses a plurality of surface vessels located on surface 1, such as first surface vessel 210 configured to store and deploy a plurality of AUVs into a body of water (e.g., a deployment vessel) and second surface vessel 220 configured to communicate with some or all of the deployed AUVs, which may be an unmanned surface vessel (“USV”) or in some embodiments a floating buoy with a communications system. Each AUV is configured to land on seabed 3. In one embodiment, each of the first and second surface vessels may comprise an acoustic positioning system 211, 221, respectively, which may be a USBL system. In other embodiments only one of the surface vessels (such as USV 220) may be equipped with a USBL system. Because second surface vessel 220 may be positioned closer to the deployed AUVs than the deployment vessel 210, the second surface vessel may provide faster and better (e.g., more accurate) positioning/communications with the AUVs. For example, towards the end of deploying the AUVs from the deployment vessel for a particular deployment line, the deployment vessel may be too far ahead along from the deployment line to accurately measure each position of the AUVs. Thus, one or more surface vessels, towed buoys, etc. configured with a USBL system may trail behind the deployment vessel so that it crosses a particular deployment line after all of the AUVs have landed and is able to better determine each AUV position on the seabed. In some embodiments, the trailing surface vessel may travel in different patterns behind the deployment vessel to improve the accuracy of the USBL system for the landed AUV positions. In one embodiment, the trailing vessel can travel much faster than the deployment vessel (and is thus able to travel via different patterns to be closer to the deployed AUVs) because the deployment vessel's speed is limited by the speed at which the AUVs can be deployed or ejected from the surface vessel as well as the AUV speed in water.

In other embodiments, only a single surface vessel may be utilized. Likewise, additional USVs or buoys may be used on the surface to better communicate with the plurality of deployed AUVs. In still other embodiments, rather than using a second surface vessel, a second non-surface vessel may be positioned beneath the water surface, such as a remotely operated vehicle (ROV), basket, or similar subsea structure positioned subsea for deep water deployment, and equipped with a USBL system or similar acoustic system for positioning/communications with each of the deployed AUVs.

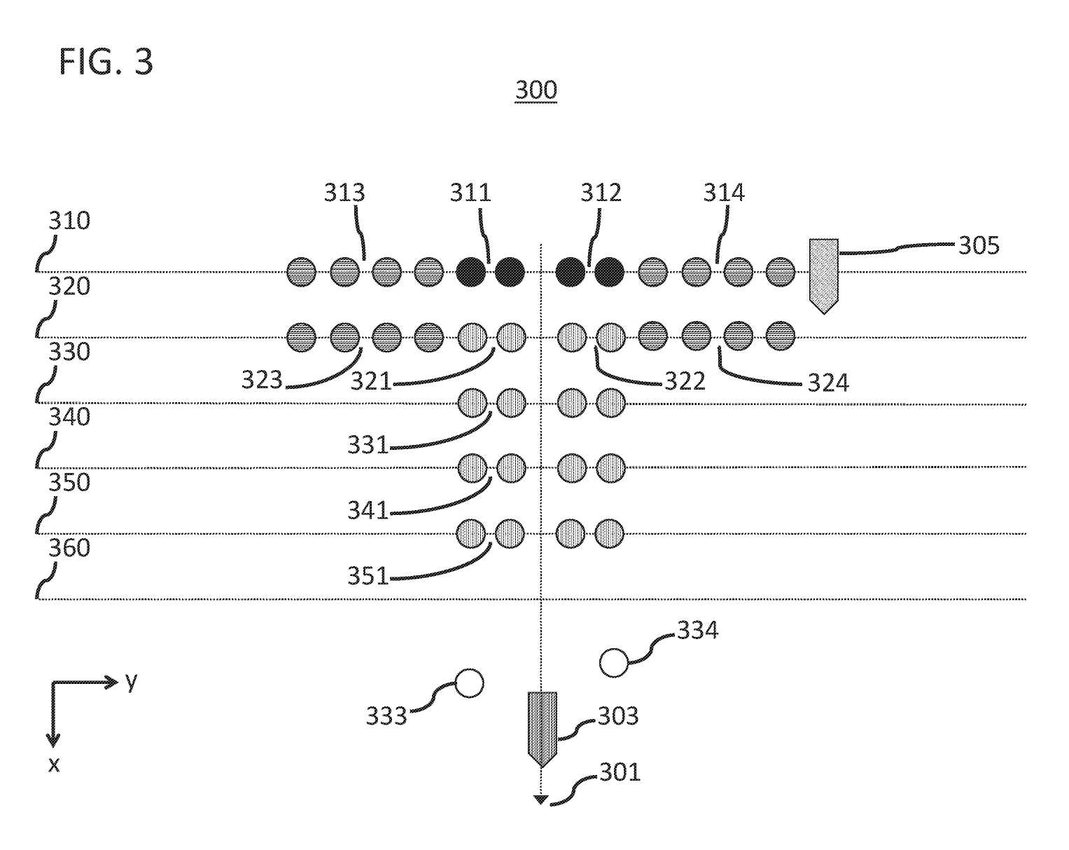

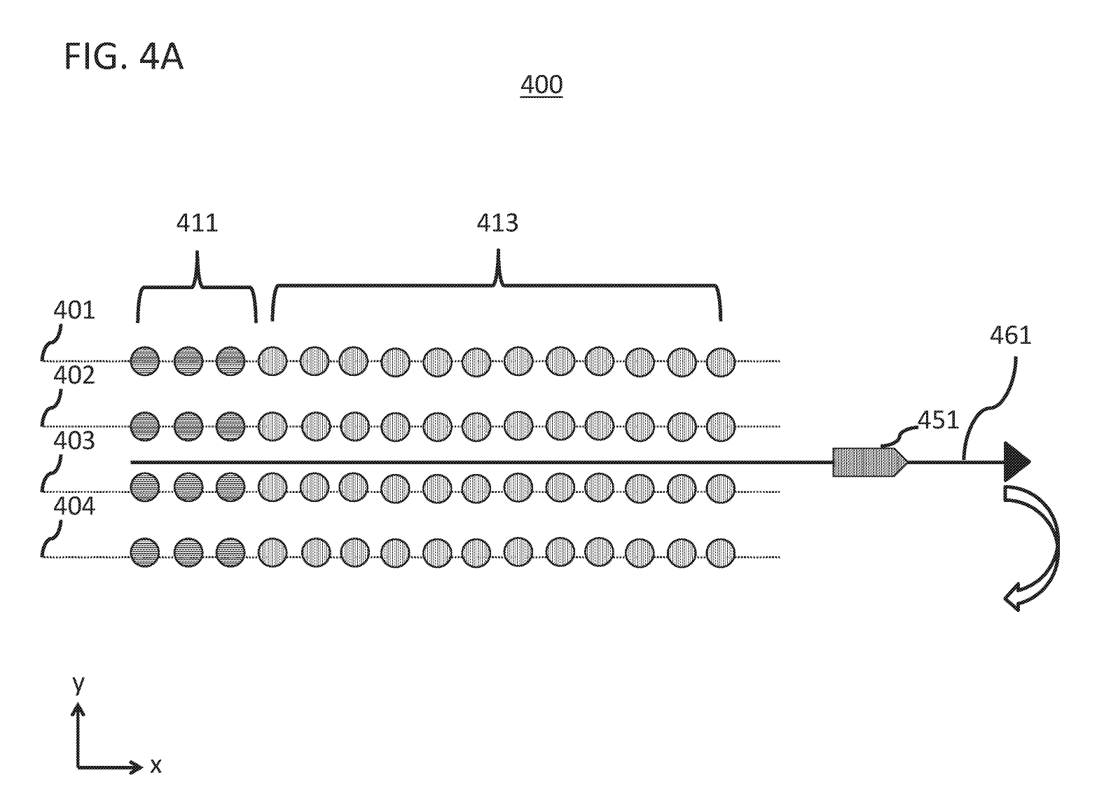

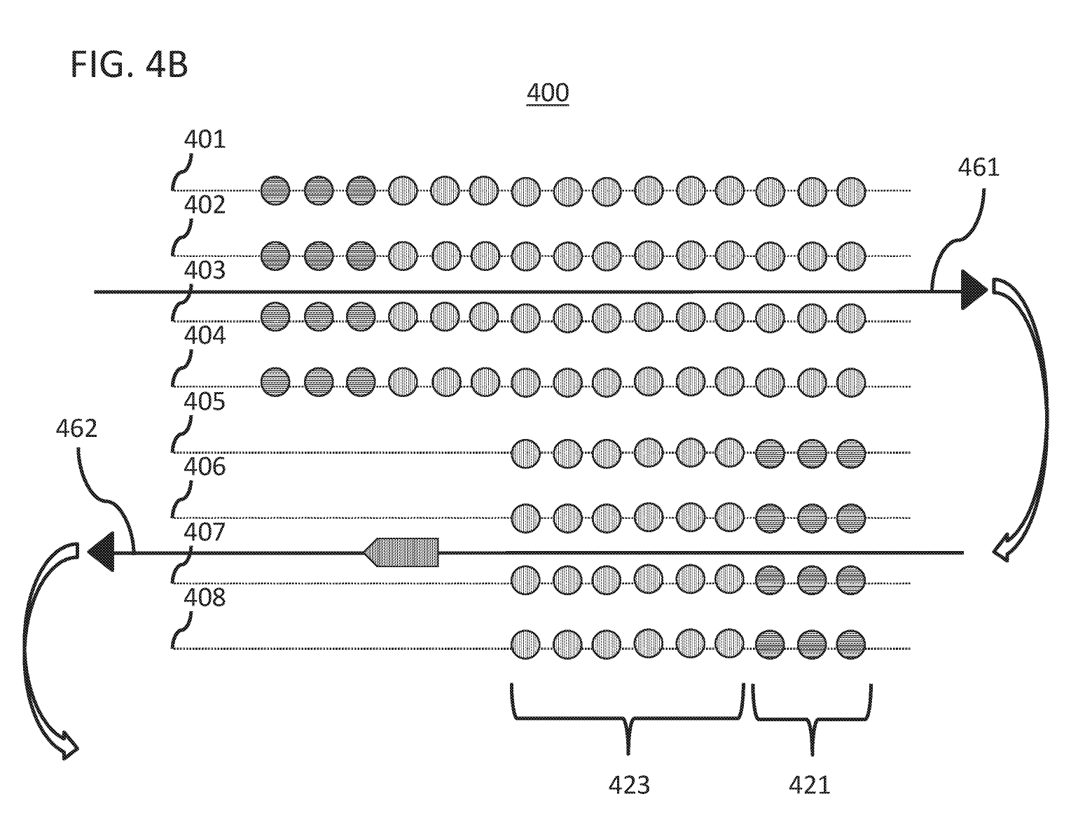

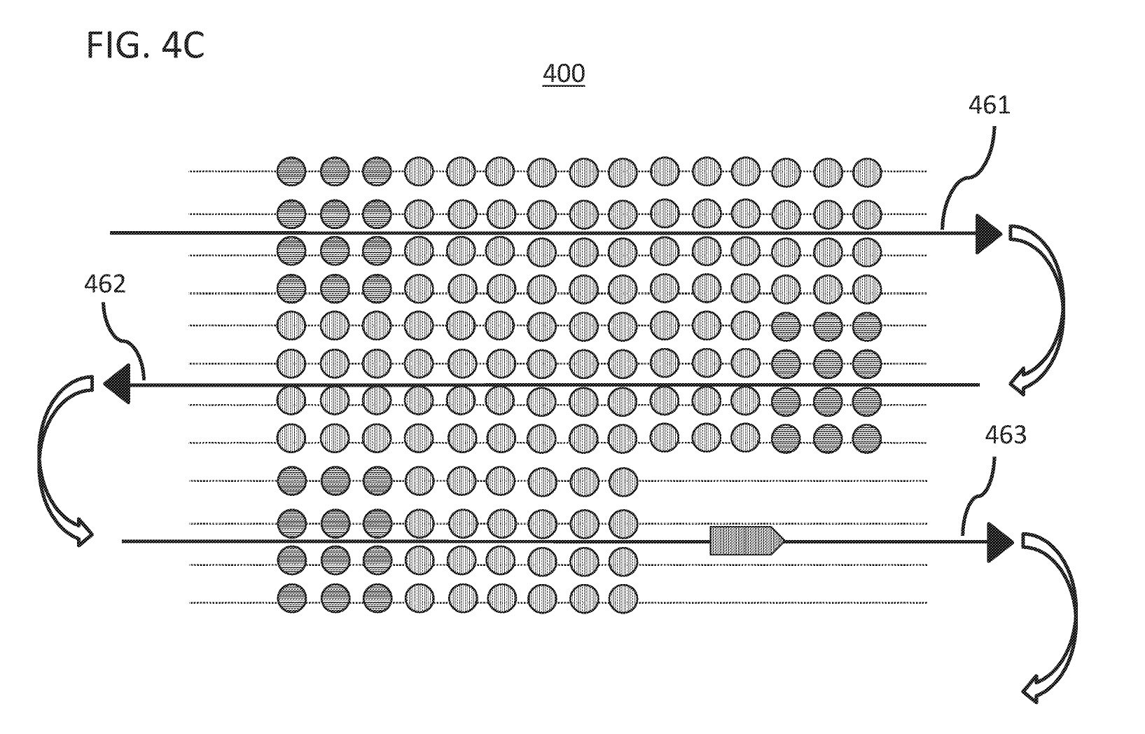

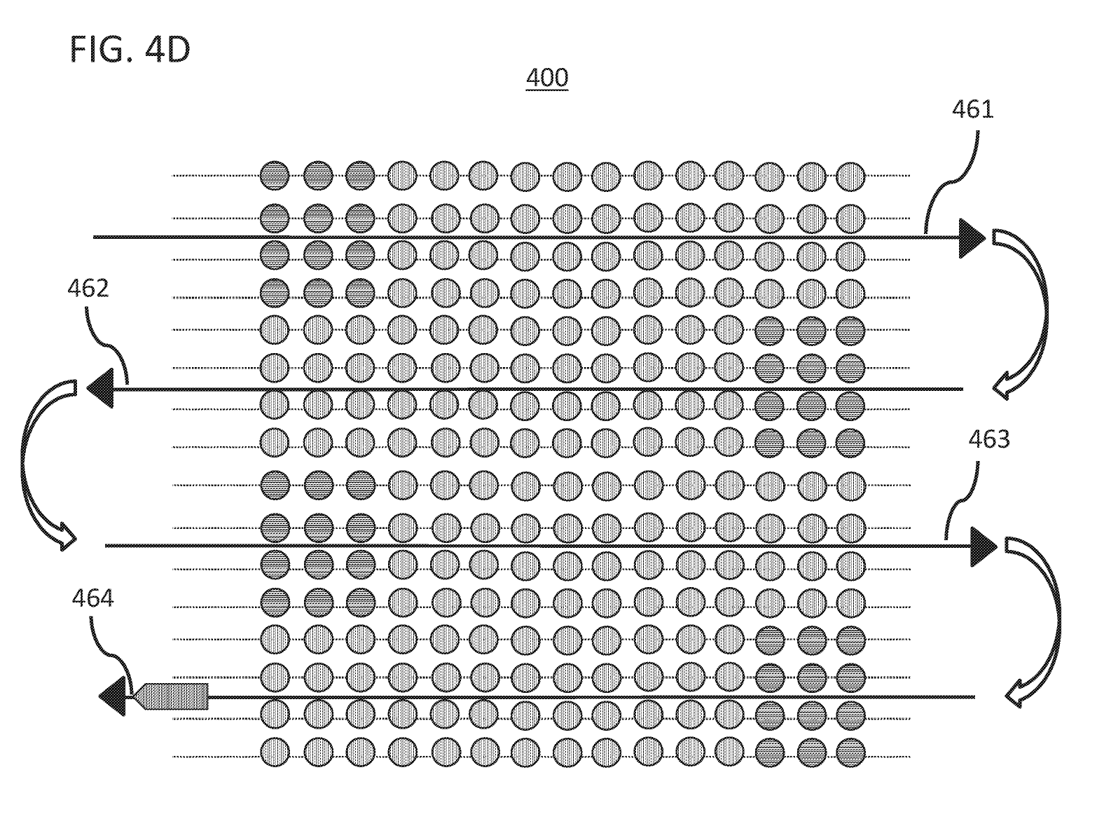

For a given seismic survey, the area to be surveyed is generally divided into a grid such that a seismic sensor node (such as a seismic AUV) may be located at a predetermined position on the seabed. In general, a deployment line is a line of predetermined seabed positions within the seismic survey area on which a plurality of seismic nodes (such as seismic AUVs) are positioned on the seabed. A wide variety of deployment line shapes and sizes are known in the art. For the present disclosure, the deployment lines may be substantially perpendicular to the direction of travel of the deployment vessel (see, e.g., FIG. 3) or may generally be in line and/or parallel with the direction of the deployment vessel (see, e.g., FIG. 4A-4D). Each deployment line may stretch up to lkm or more on each side of the deployment vessel and may contain tens or hundreds of AUVs. In one embodiment, the seismic survey may contain approximately 200 AUVs, up to 1000 AUVs, or even up to 10,000 AUVs, and under the disclosed embodiment all 10,000 AUVs may be deployed within a relatively short period of time, such as twenty-four hours. The spacing between the deployment lines and between each AUV of the deployment line depends on the particular seismic survey and is designed prior to deployment of the AUVs.

As shown in FIG. 2, multiple groups or pluralities of AUVs (such as AUV group 201, AUV group 203, and AUV group 205) may be deployed in the water at the same time and be guided to seabed destinations based on different acoustic positioning/communications and/or guidance protocols. For example, AUV group 201 has already landed on seabed 3 and may be the first AUVs of a given deployment line. For this disclosure, the first plurality of AUVs on any given deployment line may be considered as “pivots” or “pivot AUVs,” because they provide all of the positioning for subsequently deployed AUVs on a given deployment line. Pivot AUVs 201 may be actively guided to their seabed destination by a USBL system, such as USBL 221. Once pivot AUVs 201 have landed, their coordinates are known by the surface vessel (such as through an USBL system). In one embodiment, the coordinates of pivot AUVs 201 are then used as “fixed” position coordinates from which a sea bottom acoustic pinger system will emit signals intercepted and/or received by additionally deployed AUVs (such as a second plurality of AUVs 203, 205) as they are deployed from the surface vessel. Further, in one embodiment, the pinger system is part of the phased array system. Pivot AUVs 201 may emit a pulse on a given frequency (such as one frequency per deployment line to avoid interferences) after seabed landing and according to a given time sequence. Any additionally deployed AUVs may detect the pulses emitted by pivot AUVs 201 (as well as by previously landed AUVs 203, 205 once they land) and then by knowing their seabed geometry and the emission time and sequence of the pulses determine the AUV's own position and guide themselves to their pre-programmed seabed landing position.

Thus, in one embodiment, the disclosed guidance system uses a first guidance system protocol (such as USBL) to guide a first plurality of AUVs (such as pivot AUVs 201) on a first deployment line, and a second guidance system protocol (such as sea bottom acoustic pingers and phased array) to guide all of the remaining AUVs of the seismic survey and/or deployment line (such as AUVs 203, 205). For the deployment of the second plurality of seismic AUVs (which uses a one way acoustic protocol), the disclosed system is far more cost efficient, effective, and faster than traditional AUV deployment methods, such as USBL that will always suffer with the complexity of a three-way acoustic positioning/communication protocol. Further, based on the disclosed guidance system, each AUV does not require an expensive inertial navigation system (INS) or similar system, and is able to utilize relatively straightforward and known communications systems and components.

In another embodiment, the disclosed guidance system may utilize a phased array system for guiding some of the AUVs. For example, each AUV may be equipped with a phased array receiver that can detect acoustic pingers or beacons. In one embodiment, the phased array system includes a pinger that enables each of the AUVs (or at least some of the AUVs) after landing to emit pulses at an assigned frequency in an assigned time slot. By using a phase array receiver on each AUV, the AUV is able measure the angles of the incoming beacon signals from the previously landed AUVs in the same deployment line. By knowing the seabed geometry of the landed AUVs, and the sequence according to which they are emitting their signals, the travelling AUVs are able to align themselves precisely with the already landed AUVs. In some embodiments, the USBL system may be used to take control of any AUV if it is not following its pre-programmed flight path (or the phased array system is not working) and the USBL system may be used to measure each position of the AUV once it has landed on the seabed at a particular position for seismic recording.

In operation, AUVs may be deployed ahead of deployment vessel 210 so that the deployment vessel passes directly “overhead” of the AUVs after they have landed, which allows for a more precise measurement of the AUV position through the USBL system. In one operational embodiment, the pivot AUVs on a predetermined number of deployment lines are all deployed first, and then the remaining AUVs of each of the deployment lines are then deployed. In other embodiments, the pivot AUVs on each deployment line is first deployed followed by other AUVs on that deployment line prior to deploying any additional AUVs on subsequent deployment lines. In other embodiments, the timing of the deployment of the AUVs is not as important as when (and how) the AUVs calculate their position and the guidance to their seabed destination.

As is known in the art, the AUVs may be physically deployed from the deployment vessel by any number of mechanisms, and once the AUVs have performed the seismic recording on the seabed, they may be recovered to a recovery vessel from the seabed by a variety of mechanisms. In general, the particular physical deployment and recovery method and system of the AUVs is not limited by this invention. For example, as is known in the art, the AUVs may be deployed and/or retrieved directly from a surface vessel or from a subsea station, such as an ROV or subsea basket, as described more fully in Applicant's U.S. Pat. No. 9,873,496, incorporated herein by reference. In other words, the disclosed guidance method, system, and protocols can be utilized whether the AUVs are deployed directly from the surface vessel or from a subsea station in a body of water or from a subsea station (such as a basket) lowered from a surface vessel. Likewise, the AUVs may be recovered back to the same surface vessel that deployed the AUV, or to a dedicated recovery vessel that may be located on the surface or at a subsea position (such as an ROV or subsea basket). Further, the disclosed invention is not limited by the actual mechanism utilized by the AUVs for subsea movement. For example, during subsea movement of the AUV, one or more of the thrusters of the AUV propulsion system may be specifically operated to steer the AUV to the intended destination. In general, the use of horizontal and/or vertical thrusters for the seismic AUV during subsea travel, seabed landing, and seabed take-off are described in detail in Applicant's U.S. Patent Publication No. 2017/0137098, incorporated herein by reference. Again, the versatility of the disclosed seismic AUV allows it to be utilized in a wide variety of subsea deployment and retrieval operations, and the particular deployment and recovery method of the AUVs is not limited by this invention.

FIG. 3 illustrates one embodiment of an outbound guidance system that utilizes USBL, sea bottom acoustic pingers, and phased array techniques. As shown in FIG. 3, deployment system 300 includes a plurality of deployment lines, such as first deployment line 310, second deployment line 320, third deployment line 330, fourth deployment line 340, fifth deployment line 350, and sixth deployment line 360. In operation, the number of deployment lines may be substantially greater. Each deployment line may be substantially parallel to each other and substantially perpendicular to a direction 301 of deployment vessel 303. In one embodiment, a second surface vessel, such as USV 305, may travel a certain distance behind deployment vessel 303, and at times may travel at various patterns or positions away from direction 301 to be closer to a particular group of deployed/landed AUVs.

Each deployment line may have or be assigned a large number of AUVs. For the embodiment illustrated in FIG. 3, the first AUVs on any given deployment line may be considered as “pivots” or “pivot AUVs.” “Wingers” may be known as additional AUVs on a given deployment line separate from the pivot AUVs. Referring to FIG. 3, first deployment line 310 may have pivot AUVs 311, 312 and winger AUVs 313, 314. Similarly, second deployment line 320 may have pivot AUVs 321, 322 and winger AUVs 323, 324, and so forth. The pivots and wingers may be deployed on either side of the vessel. For example, pivot AUVs 311 may land on one seabed side of the deployment vessel and pivot AUVs 312 may land on the other seabed side of the deployment vessel. Similarly, winger AUVs 313 may land on one side of the surface vessel and winger AUVs 314 may land on the other side of the vessel. The number of deployment lines, as well as the number of wingers and pivots per deployment line, may vary between seismic surveys.

In one embodiment, the pivot AUVs are landed first in a row on a deployment line and, once their position finalized, the subsequent AUVs on a given deployment line then land at their seabed destinations based on coordinates of the first pivots. In other words, the coordinate positions of the pivot AUVs establish the coordinate positions of the winger AUVs on each deployment line. In one embodiment, the pivot AUVs from the first deployment line (pivot AUVs 311, 312) provide guidance and/or establish the coordinate positions of the pivot AUVs (such as pivot AUVs 321, 322, etc.) in the subsequent deployment lines.

Referring to FIG. 3, in one embodiment of operation, the pivot AUVs of the first deployment line (e.g., pivot AUVs 311, 312) are deployed from surface vessel 303 and actively guided by a USBL system (such as one located on surface vessel 303 or 305) to a predetermined seabed position. Once landed, the positions of pivot AUVs 311, 312 are then measured by a USBL system and used by the plurality of AUVs that they will guide, such as wingers 313, 314 on the first deployment line, pivot AUVs 321, 322 on the second deployment line, and subsequent pivots 331, 341, 351, and in some embodiments wingers from subsequent deployment lines, such as wingers 323, 324. As described above, based on the known coordinates of the first pivot AUVs and emitted signals, each guided AUV is able to determine is position and find its predetermined landing position by using the first pivot AUVs as effectively acoustic pingers. Thus, once the first pivot AUVs 311, 312 are guided by a first guidance system and/or protocol (such as a USBL system), all of the remaining AUVs are guided by the same USBL or a different guidance system and/or protocol (such as an acoustic pinger system with phased array system).

At or near the same time of deploying the first pivot AUVs 311, 312, wingers 313 and 314 may be deployed. Alternatively, wingers 313 and 314 may not be deployed until after all of the pivot AUVs of first deployment line 310, second deployment line 320, and third deployment line 330 (or more) have been deployed and landed. As shown in FIG. 3, AUVs 333 and 334 have recently been launched from deployment vessel 303 and are travelling and/or “flying” through the water to their intended seabed destination and may be wingers on any one of the previously established deployment lines or pivots for new deployment line 360. In one embodiment, the pivots and wingers on each deployment line are deployed at substantially the same time from the surface vessel. In other embodiments, the pivots on each deployment line are deployed at substantially the same time from the surface vessel following by subsequent deployment of the wingers, which may be done at substantially the same time or line by line. In one embodiment, AUVs are deployed on a particular deployment line on both sides of the vessel at substantially the same time. In still other embodiments, winger AUVs of earlier deployment lines may provide guidance and/or establish the coordinate positions of additional winger AUVs on subsequent deployment lines. Thus, the pivots of a given deployment line (such as the second or third deployment line) may also act as beacons in the deployment system to guide additionally deployed pivots in subsequent deployment lines (such as the fourth or fifth deployment line). In some embodiments, only the pivots of a given deployment line are used to guide the wingers of that particular deployment line.

Thus, in one embodiment, the disclosed deployment system uses a first guidance system protocol (such as USBL) to guide a first plurality of AUVs (such as pivot AUVs 311, 312) on a first deployment line, and a second guidance system protocol (such as an acoustic pinger system and phased array system) to guide a second plurality of AUVs of the seismic survey, including any wingers of the first deployment line (e.g., AUVs 313, 314), and potentially any pivots on subsequent deployment lines (e.g., AUVs 321, 322, 331, 341, 351), and potentially any wingers on the subsequent deployment lines (e.g., AUVs 323, 324).

Deployment system 300 may also use a phased array guidance approach for some or all of the wingers (or even pivots) in each deployment line. In some instances, the flying AUVs may use a phased array guidance system (discussed above and below in greater detail) to detect and process the received signals from the landed AUVs (via acoustic pingers) to calculate their position. In some embodiments, some of the wingers of a deployment line may also act as acoustic pingers for the later deployed wingers on that deployment line. Similarly, some of the wingers from an earlier deployed deployment line (such as deployment line 310) may act as an acoustic pinger for wingers in a later deployed deployment line (such as deployment lines 320, 330).

FIGS. 4A-4D illustrates another embodiment of a guidance system that utilizes USBL and phased array techniques. While similar to the embodiment described in relation to FIG. 3, in contrast to FIG. 3, the deployment lines are generally in line and/or parallel to the direction of travel of the deployment surface vessel. This approach simplifies the guidance and deployment system as compared to that described in relation to FIG. 3, and provides greater accuracy based on potential issues with triangulation using acoustic pingers.

As shown in FIGS. 4A-4D, deployment system 400 uses a deployment method that deploys seismic AUVs in one or more deployment lines on either side of the surface vessel that are in parallel and/or in-line with the surface vessel direction. For example, FIG. 4A shows two deployment lines on either side of the surface vessel, which include first deployment line 401, second deployment line 402, third deployment line 403, and fourth deployment line 404. In some embodiments, three or more deployment lines of seismic AUVs may be deployed at substantially the same time on either side of the surface vessel.

In one embodiment, each deployment line of deployment system 400 includes a first plurality of AUVs (such as AUV group 411) that provides the initial markers or boundaries for subsequently deployed AUVs (such as AUV group 413). First AUV group 411 may be guided to the predetermined seabed positions by a first guidance protocol (such as an USBL system) and second AUV group 413 may be guided to the predetermined seabed positions by a second guidance protocol (such as a phased array system). In one embodiment, second AUV group 413 is guided to the seabed positions based on signals provided by first AUV group 411 as well as some of the earlier landed AUVs within second AUV group 413.

In some embodiments, the size of the seismic survey may require multiple passes of the AUV deployment vessel by using a serpentine deployment method. For example, FIG. 4B illustrates a seismic survey with eight deployment lines, including fifth deployment line 405, sixth deployment line 406, seventh deployment line 407, and eighth deployment line 408. For this embodiment, the surface vessel makes two substantially parallel but opposite paths through the seismic survey. First, surface vessel 451 travels in direction or path 461 and deploys seismic AUVs on two deployment lines on either side of the vessel (deployment lines 401-404). After finishing deploying the particular number of seismic nodes needed for the length of the deployment line and grid in the seismic survey, the surface vessel turns around and travels in direction/path 462 that is substantially parallel and opposite to direction/path 461. Similar to the first path, the surface vessel deploys seismic AUVs on two deployment lines on either side of the vessel (deployment lines 405-408). From a top aerial perspective (see FIG. 4B), the last deployed AUVs for deployment lines 401-401 substantially align with the first deployed AUVs of deployment lines 405-408. Similar to deployment lines 401-405, each deployment line 405-408 includes a first plurality of AUVs (such as AUV group 421) that provides the initial markers or boundaries for subsequently deployed AUVs (such as AUV group 423) of that deployment line. Like the first deployment lines illustrated in FIG. 4A, first AUV group 421 may be guided to the predetermined seabed positions by a first guidance protocol (such as an USBL system) and second AUV group 423 may be guided to the predetermined seabed positions by a second guidance protocol (such as a phased array system).

This serpentine method of the surface vessel and the laying of the deployment lines may be continued until the desired number of deployment lines have been laid for the seismic survey area until the overall desired width of the seismic survey has been reached. As illustrated in FIGS. 4C and 4D, the surface vessel makes additional passes 463 and 464 and deploys additional deployment lines (not numbered) according to the procedure detailed above. In particular, the first AUVs of each deployment line act as marker or boundary AUVs and travel to the seabed destination by a first guidance protocol (such as using positioning/communications with a USBL system), while the subsequently deployed AUVs for each deployment line use a second guidance protocol (such as using acoustic emissions or pings with a phased array system). Depending on the size of the seismic survey, more or less deployment lines are possible (as well as the number of seismic nodes within each deployment line) and in operation, the number of deployment lines may be substantially greater. In another embodiment, a second surface vessel (such as a USV) or a subsea vehicle may travel a certain distance behind deployment vessel 451, and at times may travel at various patterns or positions away from the deployment vessel path to be closer to a particular group of deployed/landed AUVs.

As is known in the art, the size of the seismic survey, the number of deployment lines, and the size (e.g., length) of the deployment lines may vary between different surveys. In one embodiment, the seismic survey may comprise four to eight deployment lines (two to four deployment lines on either side of the deployment vessel) each separated by approximately 25 to 400 meters, and each deployment line may comprise approximately seismic nodes each separated by a physical distance on the seabed by 25-100 meters. Of course, these parameters may vary significantly between different seismic surveys. In one embodiment, the width of the seismic survey (i.e., the total distance between the deployment lines) is approximately 2 km or less to take into account the acoustic range of the phased array system. Thus, in one embodiment, if a seismic survey is greater than 2 km in width, the vessel must take multiple passes through the survey area in a generally serpentine method (as illustrated in FIGS. 4A-4D). However, as phased array systems become more complex in the future, increased ranges (and number) of the deployment lines may be possible.

As mentioned above, each deployment line may be assigned AUVs that are guided to predetermined seabed positions on the deployment line based on two different guidance protocols. For example, referring back to FIG. 4A, AUV group 411 comprises a first plurality of AUVs that are deployed by USBL and AUV group 413 comprises a second plurality of AUVs that are deployed by phased array. Although not marked, each subsequent deployment line of deployment system 400 likewise comprises AUVs that are deployed by either USBL or phased array. As mentioned above, the general techniques of USBL and phased array are well known. In one embodiment, first AUV group 411 comprises three AUVs, which generally provides greater accuracy (and redundancy) than just one or two AUVs. The AUVs within second AUV group 413 of deployment line 401 may be deployed at substantially the same time as the first AUV group 411 or after first AUV group 411 has landed.

In one embodiment, once the AUVs of first AUV group 411 have landed on the seabed, they start emitting acoustic emissions using pingers. Such acoustic emissions can be emitted at particular times and/or in particular patterns, as discussed in more detail below. Contrary to multi-way acoustic positioning/communication devices (which are more costly and complex), pingers are typically one-way transmission devices only and are used to determine distance and bearing from the emitted location. The AUVs within second group of AUVs 413 sense the acoustic emissions from the already landed AUVs (whether from group 411 or earlier landed AUVs from group 413) and based on those emissions, the travelling AUV is able to use a phase array system to determine the AUV's position and to correctly land at the predetermined seabed location. In one embodiment, there is no limit on the number of AUVs that may be deployed in second AUV group 413 along the length of each deployment line, but such a number depends on the overall size and density of the survey area.

Each of the travelling AUVs within AUV group 413 may detect the acoustic emissions from one or more of the previously landed AUVs. For example, a travelling node N within AUV group 413 may receive the emissions of previously landed nodes N−1, N−2, N−3, N−4, etc. of that deployment line. If one of the prior nodes has not landed (for example seismic node N−1), travelling node N may still take its place at its planned position based on the emissions of the remaining nodes (such as seismic nodes N−2, N−3, N−4). Once travelling node N lands, it will start to emit an acoustic signal that can be used to help guide subsequent seismic AUVs, such as N+1, N+2, N+3, etc. In other words, for a given deployment line, each of the AUVs within group 413 that are guided by the phased array system may use some or all of the emissions from the previously landed AUVs to guide the position of the travelling AUV to its seabed destination. In one embodiment, only the previously landed AUVs of a particular deployment line provide guidance to subsequently deployed AUVs for that same deployment line. In other embodiments, AUVs from a plurality of deployment lines may provide guidance to subsequently deployed AUVs across multiple deployment lines.

FIGS. 5A-5F illustrate a top schematic view of various operational aspects of deployment system 400 from FIGS. 4A-4D. Similar to deployment system 400, the illustrated guidance system of FIGS. 5A-5F utilizes two deployment lines on either side of deployment vessel 551 as it travels a particular direction. However, only two deployment lines 501 and 502 on a single side of the vessel are shown for clarity. In the operational position illustrated in FIGS. 5A-5F, first deployment line 501 and second deployment line 502 each have a plurality of landed seismic AUVs. For example, first deployment line 501 comprises first AUV group 511 and second AUV group 513, and second deployment line 502 comprises first AUV group 521 and second AUV group 523. Similar to deployment system 400, each of the AUVs within first AUV groups 511, 521 is deployed using USBL, and each of the AUVs within second AUV groups 513, 523 is deployed using phased array. FIGS. 5A-5F track the approach of travelling/flying AUV 561 from surface vessel 551 to seabed target position 571. In practice, a plurality of AUVs are travelling from the surface vessel to each of their intended seabed target positions at the same time. These figures also illustrate a “dog leg” navigational approach of the AUVs where the AUVs cross various deployment lines in route to the intended destination of the AUV. For the present disclosure, a “dog leg” approach is illustrated in AUV travel path 581 (FIG. 5A), which takes a first general travel direction across one or more deployment lines (e.g., 502) prior to travelling generally in-line with the intended destination deployment line (e.g., 501).

Referring to FIG. 5A, travelling AUV 561 has just been deployed from surface vessel 551 and its target position is target 571 on a predetermined point within deployment line 501. One exemplary travel path 581 for AUV 561 travels across second deployment line 502 and then moves in-line with first deployment line 501 until AUV 561 reaches its target position 571. FIG. 5B illustrates a position where surface vessel 551 continues travel in its intended direction (e.g., substantially in-line with the deployment lines) and AUV 561 is in route to target position 571 by path 582. Path 582 takes the AUV across second deployment line 502, but the AUV has not yet crossed the second deployment line. In one embodiment, at this point in time each of the previously landed AUVs (such as AUVs within AUV groups 511, 513, 521, and 523) are emitting acoustic signals (e.g., pingers) that are being continually detected by travelling AUV 561. Based on a phased array guidance system and the reception of the emitted pings, AUV 561 knows the general direction to travel towards target position 571.

FIG. 5C illustrates a position where AUV 561 is at a first “way” point when it crosses second deployment line 502 via AUV travel path 583. According to how a phased array guidance system works (which provides both a time of arrival and bearing for each received signal), AUV 561 knows that it is crossing second deployment line 502 when all of the emitted signals align from landed AUVs 521 and 523 on second deployment line 502. For example, when the bearings from each of the emitted signals from AUVs on second deployment line 502 are substantially identical, AUV 561 is substantially in-line with the other AUVs on second deployment line 502. Also shown in FIG. 5C is surface vessel 551 after it has moved a further distance away from AUV 561. For simplicity, FIGS. 5D-5F do not show the surface vessel.

FIG. 5D illustrates a position where AUV 561 is at a second “way” point when it crosses first deployment line 501 via AUV travel path 584. Again, AUV 561 knows that it is crossing first deployment line 501 when all of the emitted signals from landed AUVs 511 and 513 on first deployment line 501 align (e.g., the bearings from the emitted signals are substantially identical). At this time, the travel path of AUV 561 substantially changes from generally travelling across one or more deployment lines to travelling in-line with a particular deployment line. For example, as illustrated in FIG. 5E, because target position 571 is on first deployment line 501, once AUV 561 travels across and/or hits deployment line 501 the AUV changes to travel path 585, which is in-line with and/or along a path of deployment line 501 towards seabed target position 571. In one embodiment, the final guidance approach is illustrated by path 585 and involves AUV 561 listening to emitted signals from AUVs within deployment line 501 (and potentially ignoring signals from other deployment lines). FIG. 5F illustrates the position where AUV 561 has arrived and/or landed at the predetermined target position 571, which is substantially in-line with the other landed AUVs of first deployment line 501 (e.g., previously landed AUVs within AUV group 511 and AUV group 513). As shown, the AUV's final travel path 586 is substantially in-line with deployment line 501 as the AUV travels from its prior position as illustrated in FIG. 5E. In one embodiment, the landing approach of AUV 561 is performed according to the different signals emitted from the AUVs based a predetermined Time of Emission (“TOE”) pattern, discussed in greater detail later. After landing at position 571, AUV 561 begins to emit an acoustic signal according to a particular protocol and/or at a particular predetermined scheduled time. At this point, additional AUVs can be guided to predetermined positions on first deployment line 501 based (in part) on the acoustic signals emitted from AUV 561 (in addition to prior landed AUVs). One of skill in the art will realize that the intended travel path of the AUV may change in the final approach based on the received acoustic signals, and a travel path of the approaching AUV may move off of the deployment line from time to time based on general movements of the AUV and readjusted trajectories. In one embodiment, once the AUVs have landed and/or during landing, one or more of the AUVs may readjust their seabed positions based on the received acoustic signals from adjacent AUVs along the deployment line that landed before a particular N seismic node (N−1, N−2, etc.) as well as those that may have landed after a particular N seismic node (N+1, N+2, N+3).

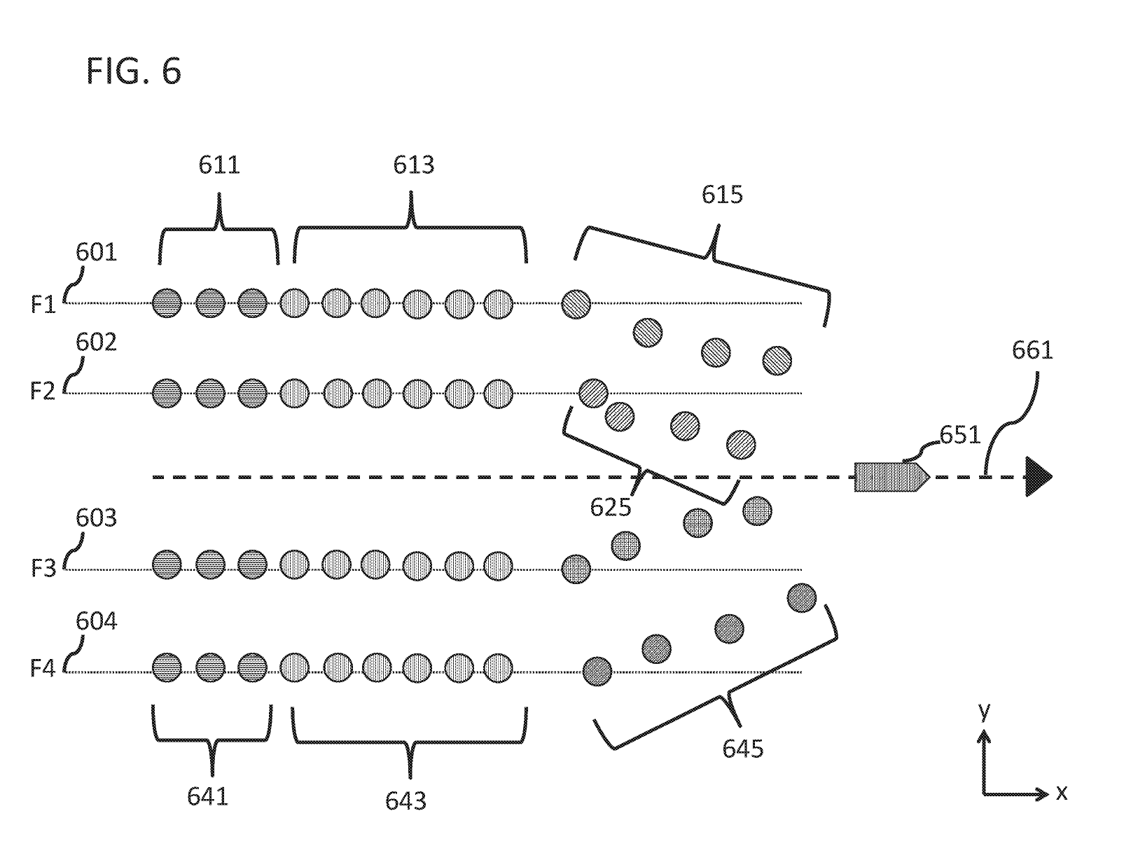

FIG. 6 illustrates a top schematic view of various operational aspects of a guidance system disclosed herein that uses a phased array system. In one embodiment, each of the AUVs assigned to a given deployment line is configured to emit an acoustic signal at a particular frequency. For example, first deployment line 601 may operate at a first frequency F1, second deployment line 602 may operate at a second frequency F2, third deployment line 603 may operate at third frequency F3, and fourth deployment line 604 may operate at a fourth frequency F4. In one embodiment, the frequencies may vary between 18 kHz and 22 kHz, with each deployment line separated by at least an interval of 0.5 kHz. For example, AUVs assigned to first deployment line 601 may operate at a frequency F1 of 22 kHz, and the remaining deployment line frequencies may be 21 kHz for F2, 20 kHz for F3, and 19 kHz for F4. Other frequencies and combinations thereof are possible as is known in the art.

FIG. 6 illustrates one embodiment of a guidance system for a plurality of landed and traveling AUVs for a plurality of deployment lines. In one embodiment, deployment vessel 651 travels along path 661 and deploys a plurality of seismic AUVs, as described above, in two deployment lines on either side of surface vessel 651. As described previously, the first plurality of AUVs (such as AUV group 611 or AUV group 641) for each deployment line (such as two or three AUVs for each deployment line) are guided to their intended seabed destinations using USBL. Phased array may or may not be additionally used for the first group of AUVs on each deployment line. After the first group of AUVs have landed, they begin emitting acoustic signals that are used to guide all of the additional AUVs for a given deployment line. AUV group 613 illustrates a group of AUVs that have already landed at their seabed destination by being guided by the phased array system. AUV group 615 illustrates a group of AUVs that have been deployed by surface vessel 651 but are still travelling/flying towards their intended seabed destination on deployment line 601 and being guided by the phased array system based on the signals emitted from some of the AUVs within groups 611 and 613. A similar arrangement is illustrated for deployment lines 602, 603, and 604. For example, deployment line 604 has a first group of AUVs 641 that have already landed by USBL, a second group of AUVs 643 that have already landed by phased array, and a third group of AUVs 645 that are travelling to their intended destination based on phased array. As noted above, the AUVs on each deployment line are configured to emit acoustic signals at a given frequency after landing on the seabed. For example, the AUVs within AUV groups 611, 613, and 615 operate at frequency F1 and the AUVs within AUV groups 641, 643, and 645 operate at frequency F4.

Traveling AUVs 615 may be deployed from surface vessel 651 and travel in a “dog leg” approach (similar to the approach illustrated in FIGS. 5A-5E), whereby they travel across deployment line 602 and then after reaching deployment line 601 travel substantially in-line with the deployment line towards the target seabed destination. In other embodiments, the traveling AUVs may or may not take a “dog leg” approach to the seabed destination. Further, the traveling AUVs may or may not cross over adjacent deployment lines. For example, travelling AUVs 615 have to cross over deployment line 602 prior to travelling to intended destination deployment line 601, but travelling AUVs 625 do not have to cross over any adjacent deployment lines other than destination deployment line 602. In one embodiment, the traveling AUVs only listen to AUVs that have previously landed on the intended destination deployment line (e.g., only AUVs at a single frequency), while in other embodiments the traveling AUVs listen to AUVs that have previously landed on a plurality of different lines (e.g., AUVs at a plurality of frequencies). In still other embodiments, the AUV may be instructed to listen to AUVs emitting signals from the same or different deployment lines as the travelling AUV based on the particular alignment and/or approach being performed by the traveling AUV.

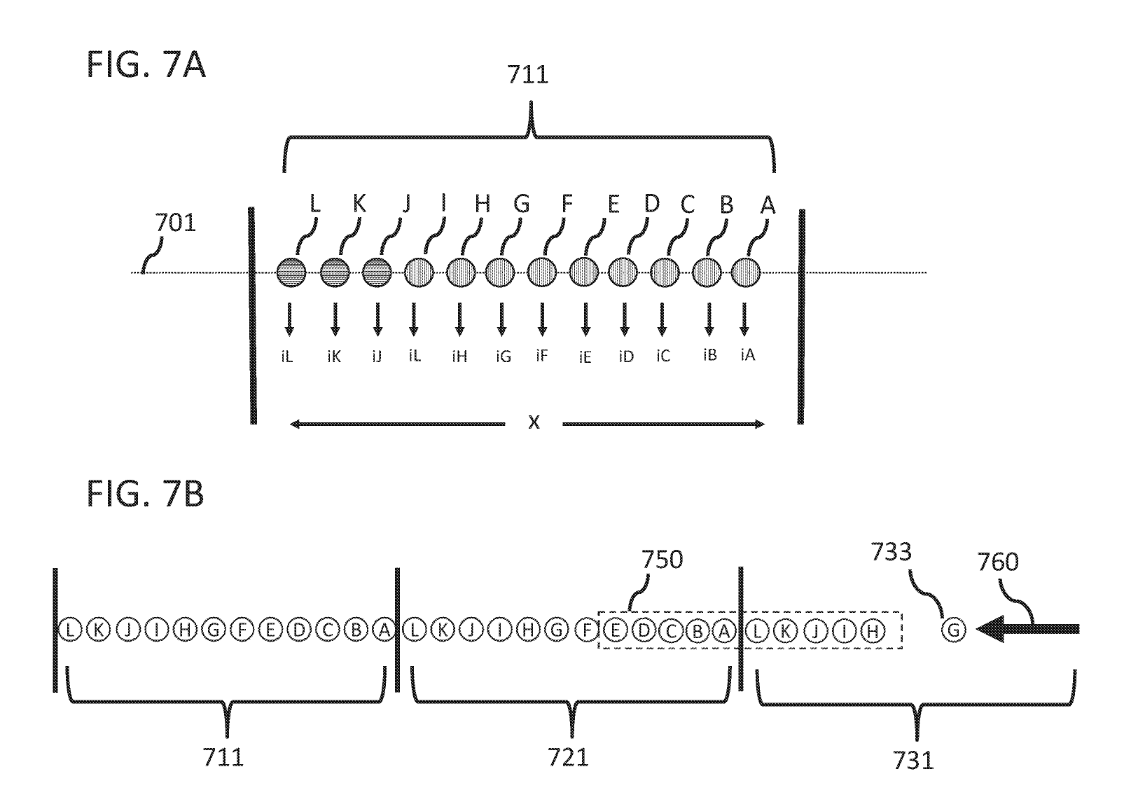

FIGS. 7A-7B illustrate a Time of Emission (TOE) system according to one embodiment of a guidance system of the present disclosure. As is known in the art, each of the seismic AUVs being deployed for the seismic survey have an accurate clock for seismic recording purposes and is synchronized to a master clock. In one embodiment, because each of the seismic nodes landing on a particular deployment line emit signals on the same frequency, there needs to be a way to differentiate the signals. For some or all of the AUVs, a TDMA (Time Division Multiple Access) approach may be used for any acoustic signal transmissions, in which each AUV is assigned a given frequency and a given time slot at a point to emit or transmit a signal so that the collectively transmitted signals do not interfere. In this embodiment, each AUV that receives such signals may be configured to assign a received signal to a specific known emitter.

In one embodiment, a TOE pattern is utilized as a way to organize the acoustic emissions of the landed AUVs by TDMA in a series of “time slots,” with each time slot devoted to the transmission of one or more AUVs. Such a TOE pattern allows the flying AUVs to exactly recognize each of the transmitting AUVs and subsequently to know the landed AUV position on the seabed. This information will be used to calculate the flying AUV's landing spot. In one embodiment, any of the previously disclosed guidance systems of the present disclosure may use a TOE pattern to assist in the guidance of the flying AUVs to the intended seabed destination. In one embodiment, the disclosed TOE pattern may also utilize Space Division Multiple Access (SDMA) principles. For the embodiment in FIG. 7B, the overall TOE pattern utilizes the SDMA principle because the same TOE pattern is deployed across seismic nodes in different repeating groups of AUVs along the entire length of the deployment line.

For example, FIG. 7A illustrates a first group of landed AUVs 711 on deployment line 701. Each of the AUVs within AUV group 711 may form a first TOE pattern. In one embodiment, AUV group 711 may comprise twelve AUVs labelled A-L, where each AUV is configured to emit an acoustic signal at time interval iA-iL. More or less AUVs are possible for a given TOE pattern. In the embodiment illustrated in FIG. 7A, the width “x” of the TOE pattern corresponds to a deployment of the AUV group 711 of approximately 1200 meters (e.g., in-line intervals of approximately 100 meters between each AUV). This distance may vary based on the number of AUVs used and the particular TOE pattern selected. In one embodiment, the selection of distance between adjacent nodes and their TOE is performed to guarantee at least a particular desired separation time between the Time of Arrival (TOA) of all received signals by a flying AUV.

In the embodiment of FIG. 7A, nodes J, K, and L (each a seismic AUV) of AUV group 711 are deployed using USBL, and seismic nodes A-I of AUV group 711 are deployed using phased array. In one embodiment, the disclosed TOE pattern avoids a “tetris effect,” in which two different AUVs may reach the same landing point based on the received acoustic signals. For example, a certain deployment line may comprise flying seismic node N, preceding nodes N−1, N−2, N−3, etc., and subsequent nodes N+1, N+2, N+3, etc. If the preceding node N−1 has not landed, flying node N will still naturally take its place at the planned N position thanks to the emissions of N−2, N−3, N−4 complying to the “TOE pattern,” and leave empty the seabed landing position of N−1. At some point after landing, seismic node N will start to emit. In some embodiments, seismic node N will start to emit immediately after landing, and in other embodiments seismic node N wait to emit until preceding seismic node N−1 has landed (even if late), or in still other embodiments start emitting after a certain time delay (considering that the preceding seismic node N−1 is lost or in failure). In such an event, a subsequently deployed seismic node may or may not be programmed to land at the seabed destination for seismic node N−1.

At a particular TOE interval, each of the AUVs emit periodically a localization pulse at a given TOE. In one embodiment, two adjacent landed AUVs have their TOE separated by a different TOE interval. In one embodiment, a TOE pattern is generated during design of the seismic survey (such as by TOE pattern generator software) to ensure the landed AUVs emit a pulse at a TOE interval that ensures that the Time of Arrival (TOA) of two consecutive acoustic pulses on an incoming AUV are separated by at least a predetermined minimum time interval. In some embodiments, the uncertainty of the TOA of such pulses may be approximately +/−20 ms, and thus the TOE interval must account for such uncertainty in the specific TOE pattern. In one embodiment, an irregular distribution of TOE intervals is utilized, such that the TOA of adjacent seismic nodes is always different so that the individual seismic nodes can be recognized. In one embodiment, each of the deployment lines utilizes the same TOE pattern.

In some embodiments, the length of the deployment line is too large to use a single TOE pattern. In this embodiment, multiple TOE groups may be utilized for a particular deployment line, which each group utilizing the same TOE pattern and having the same number of AUVs. In one embodiment, the size of the TOE pattern is designed to ensure spatial separation of AUVs having the same emitting scheme in two adjacent TOE patterns. For example, if a deployment line is approximately 10 km, a TOE pattern may be generated that is approximately 1 km in length, and thus approximately ten TOE groups may be utilized for the particular deployment line, each with the same number of AUVs. According to one embodiment of the present disclosure, each of the TOE pattern is the same and/or identical for the entire deployment line.

FIG. 7B illustrates a spatial view of one seismic AUV node deployment embodiment with repeating TOE patterns. Each group corresponding to the same TOE pattern comprises nodes labelled A-L (each a seismic AUV) and comprises a length of approximately 1200 meters (as similarly illustrated in FIG. 7A). According to one embodiment of the present disclosure, the same TOE pattern is utilized for each AUV group 711, 721, and 731. In other words, the same TOE pattern repeats itself after a predetermined distance (e.g., between different AUV groups) to ensure that the landed AUVs emitting at the same time cannot be received by any flying AUV approaching its landing position. In practice, and depending on the length of the deployment line, more AUV groups may be utilized and employ the same TOE pattern.

As illustrated in FIG. 7B (which shows a spatial view of the disclosed TOE pattern), seismic nodes A-L of AUV group 711 have landed, seismic nodes A-L of AUV group 721 have landed, and seismic nodes H-L of AUV group 731 have landed, while flying node G (marked as AUV 733) is travelling along the deployment line towards its seabed target in a general direction of path 760. In one embodiment, based on the distance between each seismic node, flying node 733 can only receive acoustic signals emitted from those AUVs in group 750 (marked by the dashed box in FIG. 7B). In one embodiment, AUV group 750 comprises less AUVs than those deployed in the utilized TOE pattern. In one embodiment, AUV group 750 may comprise previously landed nodes H-L of AUV group 731 and previously landed nodes A-E of AUV group 721. As mentioned above, the AUVs within group 750 each emit acoustic signals at different TOE intervals. After flying node 733 (G) lands, it beings to emit acoustic signals at the predetermined TOE interval. This pattern is repeated until the desired number of AUVs are deployed on the deployment line. In practice, multiple deployment lines are deployed at the same time (such as between two to eight deployment lines) using the same protocol illustrated in FIGS. 7A and 7B. In some embodiments, as described in FIGS. 4A-4D, the deploying vessel may take one or more serpentine paths through the seismic area to deploy additional sets of deployment lines to achieve a larger width of the seismic survey.

In one embodiment, the first plurality of AUVs may be deployed to the seabed without using USBL. For example, a ROV may be used to specifically place one or more seismic nodes at their predetermined positions. Those seismic nodes, at some point after being planted on the seabed, may then begin to emit acoustic signals that can be received by traveling AUVs and be guided to their seabed destinations using phased array as described herein. In other words, whether the initial marker/boundary AUVs are guided by USBL (or another guidance system) or planted by an ROV, subsequently deployed AUVs may determine their position by the disclosed phased array approach by receiving acoustic signals from landed AUVs. Still further, the marker/boundary AUVs may not be AUVs or seismic nodes at all and may simply be acoustic tags or other devices that emit acoustic signals according to a disclosed TOE pattern and are planted on the seabed at known/predetermined positions (such as by a ROV).

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the configurations of the AUV, guidance system, and/or deployment system are within the scope of the invention. For example, the AUVs in the described embodiments are shown being deployed from a surface vessel. However, the same guidance method and system described herein can be utilized for deploying AUVs from a subsea structure, such as a ROV or basket lowered from a surface vessel. Similarly, the AUVs can be recovered in a wide variety of operations known to one of skill in the art, such as being recovered at a subsea location (such as a basket, which can be lowered from and raised to a surface vessel) or travelling back to a surface vessel (such as the deployment vessel) and being recovered by a funnel, basket, or other surface recovery mechanism. As another example, other subsea vehicles can be deployed besides just autonomous seismic nodes, such as drones or vehicles with non-seismic sensors, and a similar guidance system can be used for land seismic and non-seismic sensors, drones, and/or vehicles. The deployment lines may be generally perpendicular and/or parallel to the general travel path direction of the deployment vessel. For phased array techniques, acoustic signals from landed AUVs can be timed according to any number of selected patterns, and a Time of Emission pattern may take many different forms for the AUVs within and between the deployment lines. In some embodiments, USBL is not used at all. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A method for performing a marine seismic survey in a body of water, comprising
deploying a first plurality of seismic autonomous underwater vehicles (AUVs) to a first plurality of seabed positions using a first guidance system;
deploying a second plurality of seismic AUVs into the body of water; and
guiding the second plurality of seismic AUVs to a second plurality of seabed positions using a second guidance system based on acoustic signals emitted by the first plurality of seismic AUVs after landing on the seabed.

2. The method of claim 1, further comprising guiding at least some of the second plurality of seismic AUVs based on acoustic signals emitted by previously landed AUVs within the second plurality of AUVs.

3. The method of claim 1, further comprising
deploying the first and second plurality of seismic AUVs in a plurality of deployment lines on both sides of a surface vessel, wherein each of the plurality of deployment lines is substantially parallel to the direction of travel of the surface vessel.

4. The method of claim 3, wherein each of the plurality of deployment lines comprises a plurality of landed seismic AUVs.

5. The method of claim 1, further comprising
deploying a plurality of first deployment lines on both sides of a deployment surface vessel as the vessel travels in a first direction, wherein each of the first deployment lines is substantially parallel to the first direction of travel of the vessel; and
deploying a plurality of second deployment lines on both sides of the vessel as the vessel travels in a second direction, wherein each of the second deployment lines is substantially parallel to the second direction of travel of the vessel,
wherein the second direction is substantially parallel and opposite to the first direction,
wherein each of the first and second plurality of deployment lines comprises a plurality of landed seismic AUVs guided to the seabed using phased array.

6. The method of claim 1, wherein each of the second plurality of AUVs comprises a phased array receiver that is configured to receive acoustic signals emitted by previously landed seismic AUVs.

7. The method of claim 1, wherein the first guidance system is a USBL system and the second guidance system is a phased array system.

8. The method of claim 1, further comprising
landing the second plurality of seismic AUVs on the seabed based on signals received by the first plurality of seismic AUVs and without guidance by a surface vessel.

9. The method of claim 1, further comprising
emitting acoustic pulses from a plurality of landed seismic AUVs after landing on the seabed;
receiving the emitted pulses by a plurality of flying seismic AUVs; and
determining positions of each of the plurality of flying seismic AUVs by the received emitted pulses.

10. The method of claim 9, further comprising
landing each of the plurality of flying seismic AUVs on predetermined seabed positions based on the received emitted pulses.

11. The method of claim 9, further comprising emitting acoustic pulses at a first frequency from a first plurality of landed seismic AUVs on a first deployment line and emitting acoustic pulses at a second frequency from a second plurality of landed seismic AUVs on a second deployment line.

12. The method of claim 1, further comprising guiding a flying AUV across one or more deployment lines and upon crossing an intended destination deployment line guiding the flying AUV substantially in-line with the intended destination deployment line until reaching a target seabed position on the intended destination deployment line.

13. A system for performing a marine seismic survey on the seabed, comprising
a first deployment line on the seabed comprising a first plurality of seismic AUVs and a second plurality of seismic AUVs,
wherein each AUV of the first plurality of seismic AUVs is configured to be guided to the seabed using USBL,
wherein each AUV of the second plurality of seismic AUVs is configured to be guided to the seabed using phased array based on acoustic signals emitted by the first plurality of seismic AUVs after landing on the seabed.

14. The system of claim 13, wherein each of the AUVs of the first deployment line is configured to emit acoustic pulses at a first frequency after landing.

15. The system of claim 13, wherein a time interval of the emitted pulses is determined by a Time of Emission (TOE) pattern, wherein each AUV after landing is configured to emit an acoustic pulse at a different time slot.

16. The system of claim 15, wherein the TOE pattern repeats itself a plurality of times across a plurality of different AUV groups within the first deployment line.

17. The system of claim 15, wherein the TOE pattern creates at least a predetermined minimum separation between the emitted pulses received by an approaching seismic AUV.

18. The system of claim 15, wherein the time interval is irregularly distributed.

19. The system of claim 15, wherein the time interval is configured to allow a flying AUV to determine the identity of an AUV that transmits acoustic signals according to the TOE pattern.

20. The system of claim 13, further comprising
a second deployment line on the seabed comprising a third plurality of seismic AUVs and a fourth plurality of seismic AUVs,
wherein each AUV of the third plurality of seismic AUVs is configured to be guided to the seabed using USBL,
wherein each AUV of the fourth plurality of seismic AUVs is configured to be guided to the seabed using phased array,
wherein each of the AUVs of the first deployment line is configured to emit acoustic pulses at a first frequency after landing and each of the AUVs of the second deployment line is configured to emit acoustic pulses at a second frequency after landing.
